(19) United States
(12) Patent Application Publication
(10) Pub. No.: US 2012/0176374 A1
(43) Pub. Date: Jul. 12, 2012

(54) STEREOSCOPIC EYEWEAR AND STEREOSCOPIC ELECTRONIC DEVICE

(75) Inventor: Takaaki Tanaka, Toshima-ku (JP)

(73) Assignee: Seiko Epson Corporation, Tokyo (JP)

(21) Appl. No.: 13/340,163

(22) Filed: Dec. 29, 2011

(30) Foreign Application Priority Data
Jan. 12, 2011 (JP) 2011-003720

(51) Int. Cl. G06T 15/00

(52) U.S. Cl. 345/419

(57) ABSTRACT

A projection-type display apparatus includes: a lamp unit; light bulbs corresponding to green, red, and blue colors; a prism that combines the light of the respective colors; a polarized light rotation unit, provided between the light bulb corresponding to the green color and the prism, that is capable of controlling whether to rotate the polarized light direction of incoming light and emit the light or emit the light without rotating the polarized light direction of the incoming light; and a control unit that controls the polarized light rotation unit so as to switch whether or not the polarized light direction is rotated between when a right-eye image is displayed and when a left-eye image is displayed.

### BACKGROUND

1. Technical Field

The present invention relates to techniques for viewing images stereoscopically.

2. Related Art

In the past, a frame-sequential stereoscopic scheme that causes images to be seen stereoscopically by executing time-division displays on right-eye images and left-eye images that have left/right disparity has been proposed. With this frame-sequential technique, a user dons eyewear having a right-eye shutter and a left-eye shutter that open and close in an alternating manner in synchronization with the images displayed through time division (called “active shutter eyewear”), which presents different images that reflect the right/left disparity to the right and left eyes, respectively, of the user; this results in the image being seen stereoscopically.

In a frame-sequential stereoscopic image system, a phenomenon in which the left (right) image is seen by the right (left) eye due to the response speed of liquid crystals, insufficient contrast ratios, and so on (called “crosstalk” hereinafter) is a problem.

In order to ameliorate crosstalk, JP-A-2009-152897 discloses a technique in which crosstalk between images when opening/closing left and right shuttered glasses in an alternating manner is suppressed by providing a blanking interval in which both the left and right shutters are closed.

Meanwhile, JP-A-2010-61105 discloses a technique in which crosstalk between images is suppressed by controlling the lighting/extinguishing of a light source in a projection-type display apparatus and controlling the opening/closing of shuttered glasses in synchronization therewith.

However, the technique disclosed in JPA-2009-152897 has a problem in that both the left and right shutters are closed during the blanking interval, and thus the amount of integrated light that passes through the glasses is reduced.

Furthermore, the technique disclosed in JPA-2010-61105 has a problem in that because a period in which the light source is extinguished is provided, the amount of projected light is reduced.

### SUMMARY

It is an advantage of some aspects of the invention to reduce crosstalk while ensuring a certain amount of light.

A projection-type display apparatus according to an aspect of the invention is capable of projecting a right-eye image and a left-eye image through time division, and includes: a light source; a plurality of light bulbs corresponding to a plurality of colors; a prism that combines light of the respective colors emitted from the plurality of light bulbs; a polarized light rotation unit, provided between at least one of the light bulbs and the prism, that is capable of controlling whether to rotate the polarization axis of incoming light and emit the light or emit the light without rotating the polarization axis of the incoming light; and a control unit that controls the polarized light rotation unit so as to switch whether or not the polarization axis is rotated between when the right-eye image is displayed and when the left-eye image is displayed.

According to this aspect of the invention, the right-eye image and the left-eye image are projected onto a screen through time division. In the case where the screen is, for example, a diffusion-type screen, the projected light is diffused and the polarized component is dampened as a result; however, the polarized component is not completely eliminated. Because the polarized light rotation unit switches whether or not the polarization axis is rotated between when the right-eye image is displayed and when the left-eye image is displayed, crosstalk is reduced by matching the rotation of the polarization axis of the polarized light rotation unit with the polarization axis of the right-eye shutter and the polarization axis of the left-eye shutter of stereoscopic eyewear.

According to another aspect of the invention, it is preferable for the projection-type display apparatus to output, to stereoscopic eyewear including a right-eye shutter that allows light whose polarization axis is in a first direction to pass through when open and blocks the light when closed and a left-eye shutter that allows light whose polarization axis is in a second direction to pass through when open and blocks the light when closed, a control signal instructing the right-eye shutter to open and close and the left-eye shutter to open and close; and for the control unit to control the polarized light rotation unit so that the polarization axis of emitted light from the polarized light rotation unit is in the first direction when the right-eye image is displayed and the polarization axis of emitted light from the polarized light rotation unit is in the second direction when the left-eye image is displayed.

In this case, projected light in which the polarization axis is in the first direction is projected during the display of the right-eye image, but the polarization axis of the left-eye shutter is in the second direction; accordingly, even if the response of the left-eye shutter is delayed, crosstalk can be reduced.

According to another aspect of the invention, in the aforementioned projection-type display apparatus, it is preferable for the plurality of colors to include red, green, and blue, and for the polarized light rotation unit to be provided between the light bulb that forms a green image and the prism. Because green light is more easily visible, this makes it possible to effectively suppress crosstalk.

Furthermore, according to another aspect of the invention, it is preferable, from the perspective of reducing crosstalk, for the first direction and the second direction to be orthogonal to each other.

A stereoscopic electronic device according to another aspect of the invention includes: the aforementioned projection-type display apparatus; and stereoscopic eyewear including a right-eye shutter that allows light whose polarization axis is in a first direction to pass through when open and blocks the light when closed and a left-eye shutter that allows light whose polarization axis is in a second direction to pass through when open and blocks the light when closed. According to this aspect of the invention, it is possible to reduce crosstalk while maintaining a certain amount of light.

### BRIEF DESCRIPTION OF THE DRAWINGS

The invention will be described with reference to the accompanying drawings, wherein like numbers reference like elements.

FIG. 1 is a general diagram illustrating a stereoscopic electronic device.

FIG. 2 is a diagram illustrating an example of the configuration of a projection-type display apparatus according to an embodiment of the invention.

FIG. 3 is a descriptive diagram illustrating a relationship between a liquid-crystal light bulb and a polarized light rotation unit.

FIG. 4 is a timing chart illustrating operations of a projection-type display apparatus.

FIG. 5 is a descriptive diagram illustrating operations during a left eye display period.

FIG. 6 is a descriptive diagram illustrating operations during a right eye display period.

### DESCRIPTION OF EXEMPLARY EMBODIMENTS

### 1. Embodiment

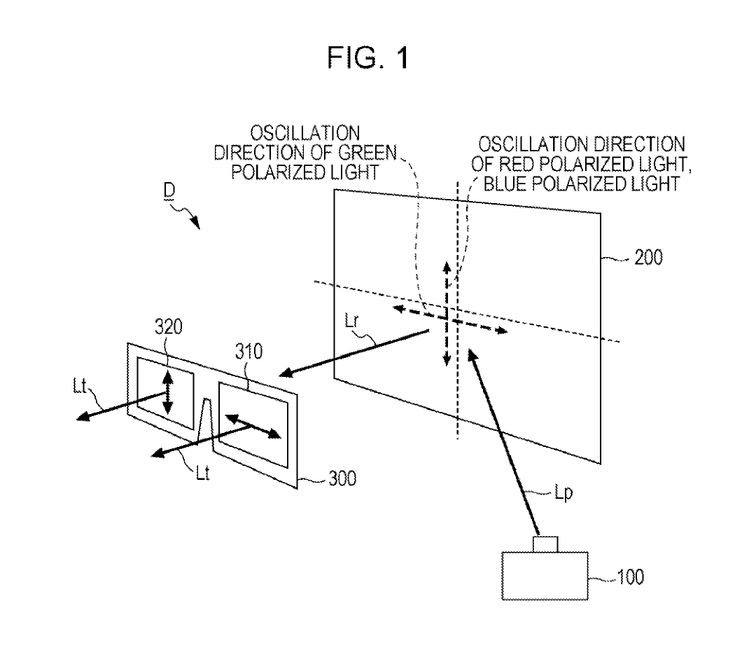

FIG. 1 is a general diagram illustrating a stereoscopic electronic device D according to an embodiment of the invention. The stereoscopic electronic device D is a display apparatus that displays color images having disparity with respect to each other so as to be capable of being seen stereoscopically, and is configured so as to include a projection-type display apparatus 100 and stereoscopic eyewear 300. The projection-type display apparatus 100 projects projected light Lp for displaying an image onto a diffusion-type screen 200. A viewer dons the stereoscopic eyewear 300. Reflected light Lr, generated when the projected light Lp is reflected off the surface of the diffusion-type screen 200, passes through the stereoscopic eyewear 300 and is sensed by the viewer.

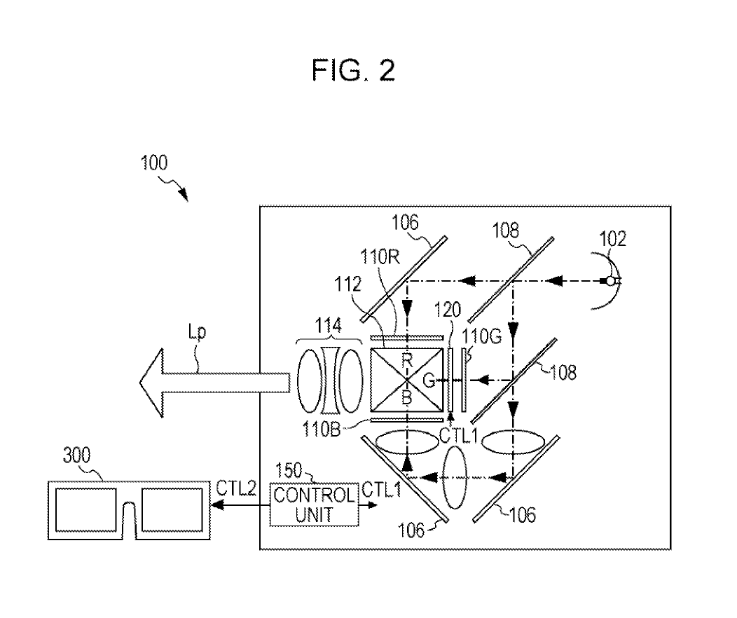

FIG. 2 is a general diagram illustrating the projection-type display apparatus. The projection-type display apparatus 100 according to this embodiment is a liquid-crystal projector that uses transmissive-type crystal panels as light bulbs 110 (110R, 110G, and 110B). A lamp unit 102 configured of a white light source such as a halogen lamp is provided within the projection-type display apparatus 100. Light emitted from this lamp unit 102 is split into red light, green light, and blue light by three mirrors 106 and two dichroic mirrors 108 disposed within the apparatus, and is led to the light bulbs 110R, 110G, and 110B, respectively, that correspond to those respective colors. Note that these light bulbs are provided with polarizers, and the light of the respective colors is modulated and polarized by the respective polarizers. Of the polarized light of the respective colors, the red polarized light and the blue polarized light have their polarization axes in the vertical direction. On the other hand, the green polarized light has its polarization axis in the horizontal direction.

The green polarized light is inputted into a polarized light rotation unit 120. The polarized light rotation unit 120 is provided between the light bulb 110G and a dichroic prism 112, and controls whether or not to rotate the polarization axis of the incoming light. In this example, the polarized light rotation unit 120 is configured of a twisted nematic (TN) liquid-crystal, which rotates the polarization axis of the green polarized light 90 degrees when a voltage is not applied thereto and outputs the light as-is, without rotating the polarization axis, when a voltage is applied thereto. For example, with green light having a wavelength of 550 nm, a refractive index anisotropy Δn and a cell gap d can be set so as to fulfill Equation (1). Note that λ represents the wavelength.

Δnd=3^{1/2}/(λ/2)=0.48 μm (1)

A first control signal CTL1 is supplied to the polarized light rotation unit 120 from a control unit 150, mentioned later, and the rotation of the polarization axis of the incoming light is controlled based thereon.

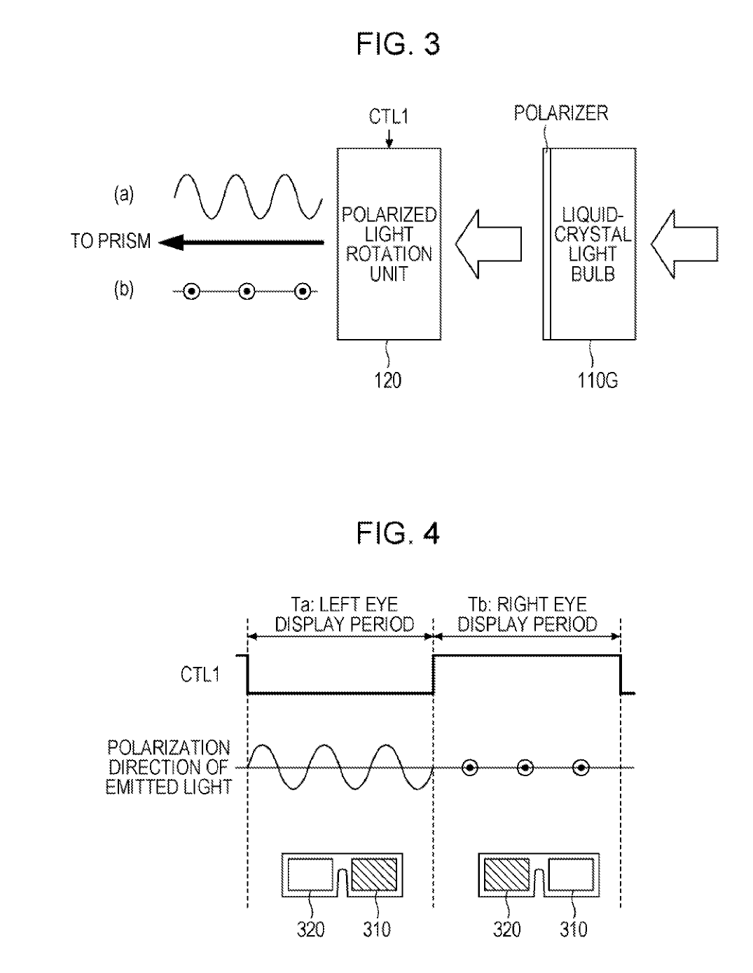

Accordingly, as shown in FIG. 3, the polarized light rotation unit 120 outputs the green polarized light whose polarization axis is in the horizontal direction as indicated by (a) in the case where the first control signal CTL1 specifies rotation, whereas the polarized light rotation unit 120 outputs the green polarized light whose polarization axis is in the vertical direction as indicated by (b) in the case where the first control signal CTL1 specifies no rotation.

The polarized light of the respective colors is inputted into the dichroic prism 112 from three directions. The red polarized light and the blue polarized light are refracted by 90 degrees in the dichroic prism 112, whereas the green polarized light proceeds straight. Through this, the projected light Lp, in which the red polarized light, the green polarized light, and the blue polarized light are intermixed, is projected onto the diffusion-type screen 200 via a projection lens 114. When the projected light Lp is projected onto the diffusion-type screen 200, the light diffuses, and the polarized component is reduced in the reflected light Lr as a result.

Incidentally, even if the diffusion-type screen 200 is used, the reflected light Lr is not completely depolarized, and the polarized component remains. With the stereoscopic eyewear 300 according to this embodiment, when a right-eye shutter 310 is in an open state, light whose polarization axis is in the horizontal direction passes through, whereas light whose polarization axis is in the vertical direction is blocked. On the other hand, when a left-eye shutter 320 is in an open state, light whose polarization axis is in the vertical direction passes through, whereas light whose polarization axis is in the horizontal direction is blocked.

However, there is delay in the response of the shutters. Accordingly, even if a signal that transits the left-eye shutter 320 from the open state to a closed state is supplied, the left-eye shutter 320 does not immediately transit to the closed state; rather, the state changes after a certain amount of delay. Assuming, for example, that a vertical-direction polarized component is present in the Reflected light Lr of the image for the right eye, as shown in FIG. 1, that component will pass through the left-eye shutter 320 and cause crosstalk. This is particularly apparent with green light, which has a higher visibility to humans.

Accordingly, in this embodiment, the polarized light rotation unit 120 is provided within the optical path of the green light, and controls the rotation of the polarization axis of the polarized green light in synchronization with the opening/closing control of the right-eye shutter 310 and the left-eye shutter 320. To be more specific, the control unit 150 generates a second control signal CTL2 that controls the opening/closing of the right-eye shutter 310 and the left-eye shutter 320 and supplies that signal to the stereoscopic eyewear 300, and also generates the aforementioned first control signal CTL1 and supplies that signal to the polarized light rotation unit 120. Note that the first control signal CTL1 and the second control signal CTL2 may be the same signal.

FIG. 4 illustrates a relationship between the first control signal CTL1 and the light emitted from the polarized light rotation unit 120. In a left eye display period Ta, the first control signal CTL1 is at low-level, whereas in a right eye display period Tb, the first control signal CTL1 is at high-level. At low-level, the first control signal CTL1 instructs the polarization axis to be rotated by 90°, whereas at high-level, the first control signal CTL1 instructs the polarization axis not to be rotated. In this example, a TN liquid-crystal is used as the polarized light rotation unit 120, and therefore in the case where the first control signal CTL1 is at low-level, a voltage is not applied to the TN liquid-crystal, whereas in the case where the first control signal CTL1 is at high-level, a voltage is applied to the TN liquid-crystal. Note that as mentioned above, the polarization axis of the polarized green light emitted from the liquid-crystal light bulb 110G is in the horizontal direction.

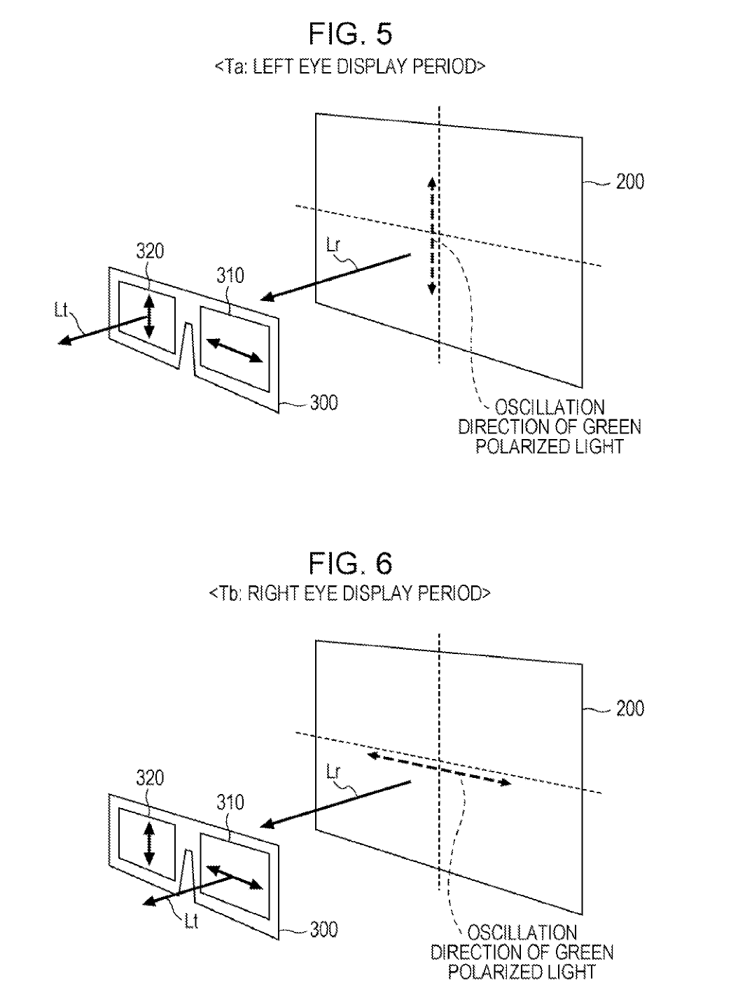

In the left eye display period Ta, the polarization axis is rotated 90° by the polarized light rotation unit 120. Accordingly, a vertical-direction polarized component is present in the green light of the reflected light Lr from the diffusion-type screen 200, as shown in FIG. 5. Because the polarization axis of the left-eye shutter 320 is in the vertical direction, the polarized component of the green light passes therethrough, but because the polarization axis of the right-eye shutter 310 is in the horizontal direction, the polarized component of the green light does not pass therethrough. As a result, it is possible to reduce crosstalk caused by the left-eye image being seen by the right eye of the viewer.

In the right eye display period Tb, the polarization axis is not rotated by the polarized light rotation unit 120. Accordingly, a horizontal-direction polarized component is present in the green light among the reflected light Lr from the diffusion-type screen 200, as shown in FIG. 6. Because the polarization axis of the right-eye shutter 310 is in the horizontal direction, the polarized component of the green light passes therethrough, but because the polarization axis of the left-eye shutter 320 is in the vertical direction, the polarized component of the green light does not pass therethrough. Through this, it is possible to reduce crosstalk caused by the right-eye image being seen by the left eye of the viewer.

In order to estimate the extent of the left-right crosstalk, a crosstalk amount CTBW that appears in a black display on one side due to the influence of a white display on the other side is illustrated by the following Equation (2).

CTBW=(GBW−GBB)/(GWB−GBB)×100(%) (2)

Note that GBW represents the light amount of the black display that has been influenced by the white display on the other side, GWB represents the light amount of the white display that has been influenced by the black display on the other side, and GBB represents the light amount in the case where both sides are a black display.

A white mat was used as the diffusion-type screen 200, and GBW, GWB, and GBB were measured by detecting the amount of light that passed through the stereoscopic eyewear 300 using a photodetector. As a result of this experiment, the crosstalk amount CTBW was approximately 5% when the polarized light rotation unit 120 was not used, whereas the crosstalk amount CTBW was improved to 1.5% by using the polarized light rotation unit 120 configured of the TN liquid-crystal.

### 2. Variations

The invention is not intended to be limited to the aforementioned embodiment, and the following variations, for example, are also possible.

(1) Although a TN liquid-crystal is used as the polarized light rotation unit 120 in the aforementioned embodiment, the invention is not limited thereto, and any configuration may be employed as long as it enables the polarization axis to be rotated. For example, liquid-crystals having various types of operation modes, such as VA (Vertical Alignment), STN (Super Twisted Nematic), FLC (Ferroelectric Liquid Crystal), OCB (Optically Compensated Bend), and ECB (Electrically Controlled Birefringence), can be employed. In the case where a VA liquid-crystal is used, the green polarized light is outputted as-is when a voltage is not applied thereto, whereas the polarization axis is rotated by 90° when a voltage is applied thereto. For example, with green light having a wavelength of 550 nm, the refractive index anisotropy An and the cell gap d can be set so as to fulfill Equation (3). Note that k represents the wavelength.

Δnd =λ2 =0.275 82 m (3)

When a VA liquid-crystal is used as the polarized light rotation unit 120 and the crosstalk amount CTBW is found through the same type of experiment described in the aforementioned embodiment, the crosstalk amount CTBW was approximately 5% when the polarized light rotation unit 120 was not used, whereas the crosstalk amount CTBW was improved to 0.8% by using the polarized light rotation unit 120 configured of the VA liquid-crystal. In this manner, it is possible to further reduce crosstalk by employing a VA liquid-crystal.

(2) Although the aforementioned embodiment and variation describe an example in which a blanking interval, in which both the right-eye shutter 310 and the left-eye shutter 320 are closed at the same time, is not provided, the invention is not limited thereto, and the crosstalk may be further reduced by providing a blanking interval.

(3) Although in the aforementioned embodiment and variation, the polarized light rotation unit 120 is not provided for the red light and the blue light, the polarized light rotation unit 120 may be provided for either or both of these lights. In this case, the polarized light rotation unit 120 can be provided between the liquid-crystal light bulb 110R and the prism 112, and between the liquid-crystal light bulb 110B and the prism 112, so that the polarization directions of the respective lights match.

This application claims priority to Japan Patent Application No. 2011-003720 filed Jan. 12, 2011, the entire disclosures of which are hereby incorporated by reference in their entireties.

What is claimed is:

1. A projection-type display apparatus capable of projecting a right-eye image and a left-eye image through time division, the apparatus comprising:
a light source;
a plurality of light bulbs corresponding to a plurality of colors;
a prism that combines light of the respective colors emitted from the plurality of light bulbs;
a polarized light rotation unit, provided between at least one of the light bulbs and the prism, that is capable of controlling whether to rotate the polarization axis of incoming light and emit the light or emit the light without rotating the polarization axis of the incoming light; and
a control unit that controls the polarized light rotation unit so as to switch whether or not the polarization axis is rotated between when the right-eye image is displayed and when the left-eye image is displayed.

2. The projection-type display apparatus according to claim 1, the apparatus outputting, to stereoscopic eyewear including a right-eye shutter that allows light whose polarization axis is in a first direction to pass through when open and blocks the light when closed and a left-eye shutter that allows light whose polarization axis is in a second direction to pass through when open and blocks the light when closed, a control signal instructing the right-eye shutter to open and close and the left-eye shutter to open and close,
wherein the control unit controls the polarized light rotation unit so that the polarization axis of emitted light from the polarized light rotation unit is in the first direction when the right-eye image is displayed and the polarization axis of emitted light from the polarized light rotation unit is in the second direction when the left-eye image is displayed.

3. The projection-type display apparatus according to claim 1,
wherein the plurality of colors includes red, green, and blue; and
the polarized light rotation unit is provided between the light bulb that forms a green image and the prism.

4. The projection-type display apparatus according to claim 1, wherein the first direction and the second direction are orthogonal to each other.

5. A stereoscopic electronic device comprising:
the projection-type display apparatus according to claim 1; and
stereoscopic eyewear including a right-eye shutter that allows light whose polarization axis is in a first direction to pass through when open and blocks the light when closed and a left-eye shutter that allows light whose polarization axis is in a second direction to pass through when open and blocks the light when closed.

6. A stereoscopic electronic device comprising:
the projection-type display apparatus according to claim 2; and
stereoscopic eyewear including a right-eye shutter that allows light whose polarization axis is in a first direction to pass through when open and blocks the light when closed and a left-eye shutter that allows light whose polarization axis is in a second direction to pass through when open and blocks the light when closed.

7. A stereoscopic electronic device comprising:
the projection-type display apparatus according to claim 3; and
stereoscopic eyewear including a right-eye shutter that allows light whose polarization axis is in a first direction to pass through when open and blocks the light when closed and a left-eye shutter that allows light whose polarization axis is in a second direction to pass through when open and blocks the light when closed.

8. A stereoscopic electronic device comprising:
the projection-type display apparatus according to claim 4; and
stereoscopic eyewear including a right-eye shutter that allows light whose polarization axis is in a first direction to pass through when open and blocks the light when closed and a left-eye shutter that allows light whose polarization axis is in a second direction to pass through when open and blocks the light when closed.
